(19) United States
(12) Patent Application Publication
(10) Pub. No.: US 2006/0051678 A1
(43) Pub. Date: Mar. 9, 2006

(54) Lithium ion rechargeable battery

(76) Inventors: Jong Ku Kim, Cheonan-si (KR); Akihiko Saito, Cheonan-si (KR)

Correspondence Address: H.C. PARK & ASSOCIATES, PLC, 8500 LEESBURG PIKE, SUITE 7500, VIENNA, VA, 22182, US

(21) Appl. No.: 11/189,812

(22) Filed: Jul. 27, 2005

(30) Foreign Application Priority Data
Jul. 28, 2004 (KR) 2004-0059431

(51) Int. Cl. H01M 2/18

(52) U.S. Cl. 429/246; 429/130

(57) ABSTRACT

A lithium ion rechargeable battery has an insulation layer positioned on a protrusion formed on both ends of a coated portion of an electrode assembly to reduce the possibility of an internal short circuit between electrode plates and to minimize the decrease in battery capacity.

### CROSS REFERENCE TO RELATED APPLICATION

This application claims priority to and the benefit of Korean Patent Application No. 2004-0059431, filed on Jul. 28, 2004, which is hereby incorporated by reference for all purposes as if fully set forth herein.

### BACKGROUND OF THE INVENTION

1. Field of the Invention

The present invention relates to a lithium ion rechargeable battery that has an insulation layer positioned on a protrusion that is formed on both ends of a coated portion of an electrode assembly to reduce the possibility of an internal short circuit between electrode plates and to minimize the decrease in battery's power storage capacity.

2. Description of the Background

Rechargeable batteries are widely used as the power source for portable electronic devices including camcorders, portable computers, and portable telephones because they are rechargeable and may have a compact size with large capacity. Typical examples of recently developed rechargeable batteries include nickel metal hydrogen (Ni—MH) batteries, lithium (Li) ion batteries, and lithium ion polymer batteries.

Lithium ion rechargeable batteries include a bare cell that is formed by placing an electrode assembly comprised of a positive electrode plate, a negative electrode plate, and a separator into a can made of aluminum or an aluminum alloy. The can is topped with a cap assembly, an electrolyte is injected into the can, and the can is sealed. In polymer batteries, an electrode plate or a separator is made up of a polymer and it may additionally play the role of an electrolyte or have an electrolyte component impregnated therein. Given this configuration, there is little possibility that the electrolyte may leak, and a pouch may be used instead of the can.

The electrode plates of lithium ion rechargeable batteries are formed by applying a slurry including electrode active materials such as lithium oxide for a positive electrode and a carbon material for a negative electrode to a surface of an electrode collector which usually comprises a metal foil. The slurry is prepared by mixing a solvent, a plasticizer, electrode active materials, and a binder. The electrode collector usually comprises copper for a negative electrode plate and aluminum for a positive electrode plate. The binder may comprise polyvinylidene fluoride or styrene butadiene rubber, and the solution may comprise acetone or N-methylpyrrolidone. Water may be used as the solvent, for example.

As a slit die for supplying a slurry passes uniformly over the upper surface of the electrode collector, a coated portion is formed on a surface of the electrode collector with a predetermined thickness. The slurry that is supplied through the slit die contains a high concentration of a solvent in a fluid state. The solvent is volatilized in a drying process, and the slurry strongly adheres to the electrode collector by means of the binder.

The electrode collector is coated with the electrode active materials to form a coated portion which has a predetermined length necessary to form a single electrode. A strip portion also referred to as an uncoated portion that has no active material coated on it, is interposed between the coated portions to weld a tab thereto, for example. As such, the electrode collector includes a coated portion and an uncoated portion.

When the electrode collector is coated with a slurry, the slurry may coagulate on and protrude from initial and final coated portions, compared with other portions that are uniformly coated with the electrode active materials. Such protrusions may appear on both ends of the coated portion of the negative electrode plate and the positive electrode plate that are coated with the slurry. When the electrode assembly is subjected to pressure during a winding process or another external pressure, the pressure may be concentrated on the protrusions and damage the separator. If an internal short circuit occurs due to the damaged separator, the production yield of batteries may decrease and a safety concerns may arise.

FIG. 1A and FIG. 1B are sectional and top views, respectively, of a conventional electrode collector that has a coated portion formed on a surface thereof and an insulation layer formed on a protrusion of both ends of the coated portion. It will be apparent to those skilled in the art that although only one of the positive electrode plate and negative electrode plate is shown in FIG. 1A and FIG. 1B, both plates may have an insulation layer formed thereon.

An insulation layer 20 may be formed on a part of a coated portion 14 including a protrusion 16 that is formed on at least one of a positive electrode plate and a negative electrode plate 10 as shown in FIG. 1A and FIG. 1B, to solve the above mentioned problem. The insulation layer 20 is generally formed by attaching an insulation tape to surround the protrusion 16 of the coated portion 14. An insulation tape or a laminating tape comprising material that has resistance to an electrolyte is used as the insulating layer 20.

However, the insulation layer 20 covers a part of the coated portion 14 and reduces its reaction area. The power storage capacity of a lithium ion rechargeable battery is proportional to the area of the coated portions. If an insulation layer 20 is attached to the coated portion, the reaction area of the coated portions 14 decreases, thus decreasing the battery's capacity. Specifically, the reduction in the reaction area of the positive electrode coated portion causes the decrease in battery capacity.

### SUMMARY OF THE INVENTION

The present invention provides a lithium ion rechargeable battery that has an insulation layer positioned on a protrusion that is formed on both ends of a coated portion of an electrode assembly. The insulation layer reduces the possibility of an internal short circuit between electrode plates and minimizes the decrease in battery capacity.

Additional features of the invention will be set forth in the description which follows, and in part will be apparent from the description, or may be learned by practice of the invention.

The present invention discloses a lithium ion rechargeable battery comprising an electrode assembly formed by winding a positive electrode plate and negative electrode plate having a coated portion formed on a surface thereof and a separator that insulates the positive electrode plate and the negative electrode plate from each other. The battery further comprises an insulation layer that surrounds at least one of the protrusions that is formed on both ends of the coated portion of at least one of the positive electrode plate and the negative electrode plate, wherein the insulation layer has a through-hole that is formed with a predetermined shape.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A and FIG. 1B are sectional and top views, respectively, of a conventional electrode collector having a coated portion that is formed on a surface thereof and an insulation layer that is formed on the protrusion of both ends of the coated portion.

FIG. 2A is a top view of a positive electrode plate having an insulation layer formed on a protrusion of a positive electrode coated portion thereof according to an exemplary embodiment of the present invention.

FIG. 2B is a sectional view of the positive electrode plate shown in FIG. 2A.

FIG. 3A is a top view of an insulation tape used for the insulation layer shown in FIG. 2A.

FIG. 3B is a sectional view of the insulation tape shown in FIG. 3A.

FIG. 4 is a top view of an insulation tape according to another exemplary embodiment of the present invention.

FIG. 5 is a top view of an insulation tape according to another exemplary embodiment of the present invention.

FIG. 6A is a top view of a positive electrode plate having an insulation layer formed on a protrusion of a positive electrode coated portion thereof according to another exemplary embodiment of the present invention.

FIG. 6B is a sectional view of a positive electrode plate having an insulation layer formed on a protrusion of a positive electrode coated portion thereof according to another exemplary embodiment of the present invention.

FIG. 7 is a top view of an insulation tape used for the insulation layer shown in FIG. 6A.

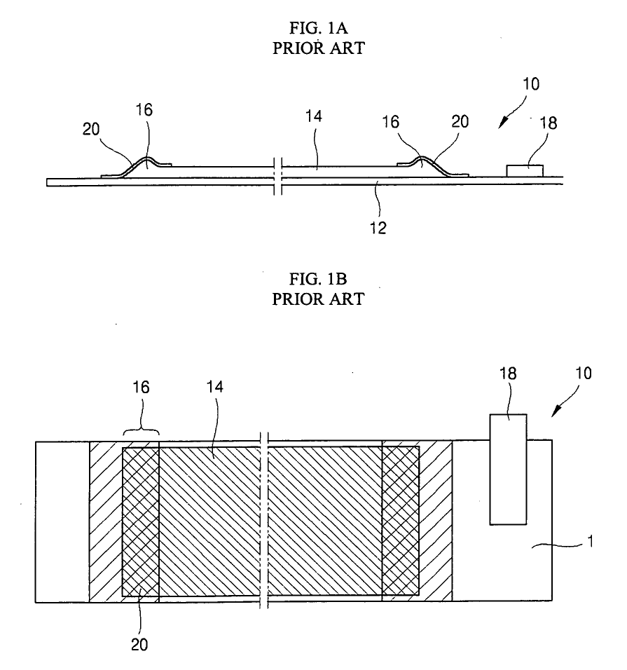

### DETAILED DESCRIPTION OF THE ILLUSTRATED EMBODIMENTS

In the present invention, the protrusion formed on both ends of the coated portion of the electrode collector is surrounded by an insulator to reduce the possibility of an internal short circuit between both electrodes and to minimize the decrease in the capacity of rechargeable batteries.

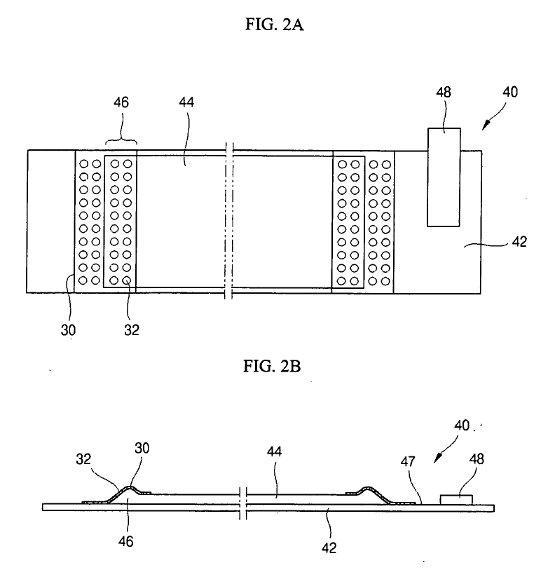

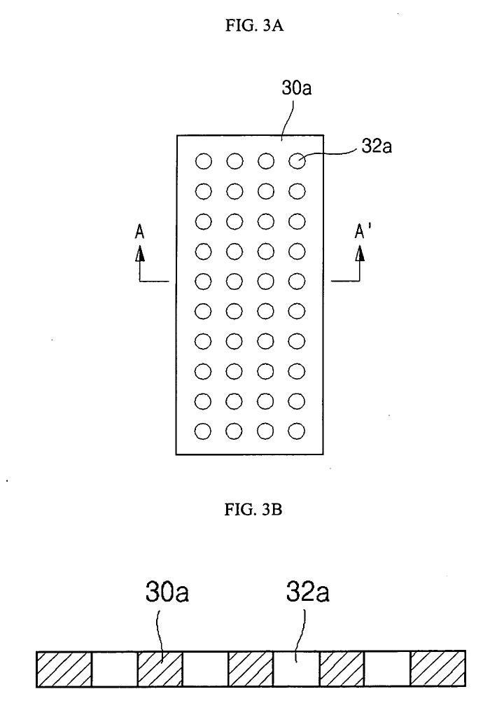

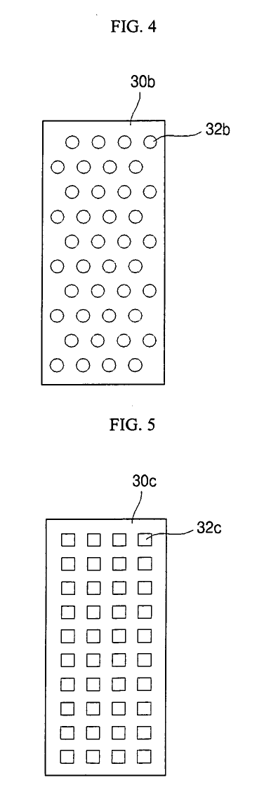

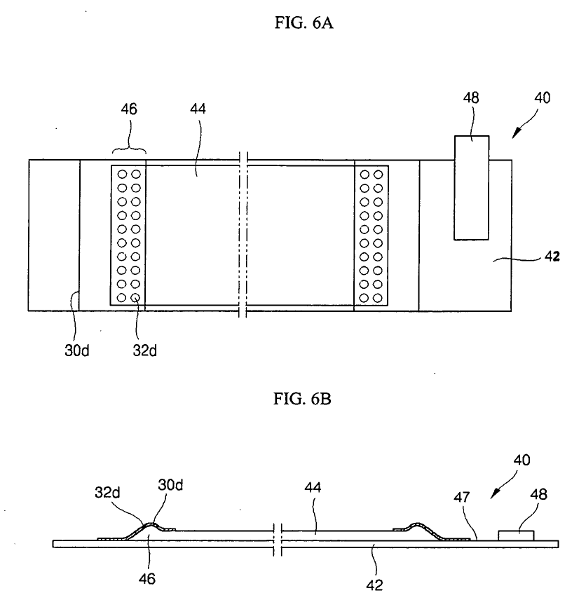

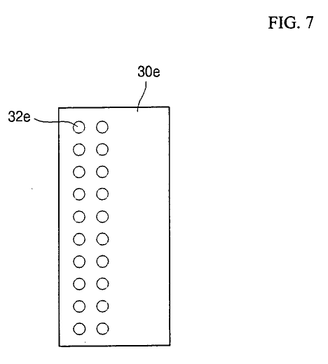

FIG. 2A is a top view of a positive electrode plate having an insulation layer formed on a protrusion of a positive electrode coated portion thereof according to an exemplary embodiment of the present invention. FIG. 2B is a sectional view of the positive electrode plate shown in FIG. 2A. FIG. 3A is a top view of an insulation tape used for the insulation layer shown in FIG. 2A. FIG. 3B is a sectional view of the insulation tape shown in FIG. 3A. FIG. 4 is a top view of an insulation tape according to another exemplary embodiment of the present invention. FIG. 5 is a top view of an insulation tape according to another exemplary embodiment of the present invention. FIG. 6A is a top view of a positive electrode plate having an insulation layer formed on a protrusion of a positive electrode coated portion thereof according to another exemplary embodiment of the present invention. FIG. 6B is a sectional view of a positive electrode plate having an insulation layer formed on a protrusion of a positive electrode coated portion thereof according to another exemplary embodiment of the present invention. FIG. 7 is a top view of an insulation tape used for the insulation layer shown in FIG. 6A.

A lithium ion rechargeable battery according to the present invention includes an electrode assembly (not shown in the drawing) that is formed by winding a positive electrode plate and a negative electrode plate having a coated portion formed on a surface of an electrode collector and a separator for insulating the positive electrode plate and the negative electrode plate from each other. The battery further comprises an insulation layer for covering an end of the coated portion of at least one of the positive electrode plate and the negative electrode plate.

The assembly of the electrode collector, the electrode uncoated portion, and the electrode tab of the positive electrode plate and the negative electrode plate of the electrode assembly is the same as has been described in the prior art. A repeated description thereof will be omitted. It is obvious to those skilled in the art that the following description regarding the positive electrode plate can be equally applied to the negative electrode plate.

Referring to FIG. 2A and FIG. 2B, the insulation layer 30 is formed with a predetermined width to substantially cover the initial portion and the final portion 46 of a positive electrode coated portion 44, which is formed on a surface of a positive electrode collector 42 of a positive electrode plate 40. The insulation layer 30 has at least one through-hole 32 formed thereon with a predetermined shape. The insulation layer 30 preferably has a number of small through-holes 32 that are formed thereon. If the through-holes 32 are too large, the insulation layer 30 cannot sufficiently cover the protrusion 46 and a short circuit may occur between the electrode plates. Therefore, at least five through-holes 32 are preferably formed on the positive electrode coated portion 44.

The total area of the through-holes 32 corresponds to about 30-90% of the area of the insulation layer 30 that is formed on the positive electrode coated portion 44. If the total area of the through-holes 32 that are formed on the positive electrode coated portion 44 is less than 30% of the area of the insulation layer 30 that formed on the positive electrode coated portion 44, it becomes difficult to effectively prevent the decrease in battery capacity. If the total area of the through-holes 32 that are formed on the positive electrode coated portion 44 is more than 90% of the area of the insulation layer 30 that is formed on the positive electrode coated portion 44, the insulation layer 30 cannot sufficiently prevent a short circuit between the positive electrode plate and the negative electrode plates caused by the protrusion 46 of the positive electrode coated portion 44.

The insulation layer 30 may comprise an insulation tape or a resin coating. The insulation tape may be made up of a laminating tape or an adhesion tape. Specifically, the laminating tape may be attached to an object by heat without additional adhesive and the adhesion tape may be attached to an object by an adhesive that is applied on the lower portion of the tape.

The insulation layer 30 may comprise a material including, but not limited to polyphenylene sulfide, polyimide, and polypropylene which has resistance to the electrolyte used in the lithium ion rechargeable batteries and has excellent thermal resistance so that it does not deform (Ex: contract) at a temperature of 150° C. or higher. The insulation layer 30 preferably has a thickness of about 5-200 μm. If the insulation layer 30 has a thickness less than 5 μm, it 5 cannot cover the protrusion 46 of the positive electrode coated portion 44 and a short circuit may occur between the electrode plates. If the insulation layer 30 has a thickness greater than 200 μm, the thickness of the electrode assembly partially increases.

Reference numeral 48 refers to a positive electrode tab that is welded to the positive electrode uncoated portion 47 of the positive electrode collector 42.

Referring to FIG. 3A and FIG. 3B, the insulation layer 30a is a tape that has a predetermined width and has through-holes 32a that are formed thereon with a predetermined size. Although the through-holes 32a extend through the insulation layer 30a in the vertical direction and are arranged in rows with a predetermined spacing as shown in FIG. 3a, the arrangement is not limited herein. The through-holes may not be formed with a predetermined spacing or array. The through-holes 32b may be formed on the insulation layer 32b in a zigzag or staggered configuration as shown in FIG. 4. In that case, the protrusion 46 can be covered effectively even when the through-holes 32b are positioned on the protrusion 46 of the positive electrode coated portion 44. As mentioned above, the total area of the through-holes 32a and 32b corresponds to about 30-90% of the area of the insulation layer 30a and 30b that is attached to the positive electrode coated portion 44.

FIG. 5 is a top view of an insulation tape according to another exemplary embodiment of the present invention.

The insulation layer 30c has square-shaped through-holes 32c formed thereon. In addition, the through-holes 32c may have various polygonal shapes including a pentagon.

FIG. 6A and FIG. 6B are top and sectional views respectively, of a positive electrode plate having an insulation layer formed on a protrusion of a positive electrode coated portion thereof according to another exemplary embodiment of the present invention.

Referring to FIG. 6A and FIG. 6B, the insulation layer 30d has through-holes 32d that are formed only on a region that is formed on the positive electrode coated portion 44 and has no through-hole 32d formed in the positive electrode uncoated portion 47 of the positive electrode 40. More particularly, the insulation layer 30d has through-holes 32d formed thereon to prevent the positive electrode coated portion 44 from being covered by the insulation layer 30d and to increase the area of the positive electrode coated portion 44 that reacts with the negative electrode coated portion. Therefore, the insulation layer 30d on the positive electrode uncoated portion 47, does not need to have through-holes 32d formed thereon. As such, the insulation layer remains intact in the positive electrode uncoated portion 47 and completely maintains the insulation effect.

FIG. 7 is a top view of an insulation tape used for the insulation layer shown in FIG. 6A.

Referring to FIG. 7, the insulation layer 30e has through-holes 32e that are formed only in a region that is attached to the positive electrode coated portion 44 and no through-holes formed on a region that is attached to the positive electrode uncoated portion 47. In the present embodiment of the insulation layer 30e, the decrease in the reaction area of the positive electrode coated portion 44 of the positive electrode plate 40 is minimized as is the reduction in battery capacity. The insulation layer 32e remains intact in the positive electrode uncoated portion 47 and maintains the insulation effect. Preferably at least five through-holes 32e are formed in the insulation layer 30e on the positive electrode coated portion 44. The area of the through-holes 32e corresponds to about 30-90% of the total area of the insulation layer 30e that is formed on the positive electrode coated portion 44.

The taping process for forming the insulation layer according to the present invention may be performed in a batch mode after applying and drying the positive electrode coated portion in a process for forming the electrode. It may also be conducted automatically with automatic equipment which memorizes both ends of the positive electrode coated portion.

Of course, the insulation layer may also be formed on the negative electrode plate, in addition to the positive electrode plate, as mentioned above. The insulation layer may 20 be formed on at least one end of each coated portion of the positive electrode plate and the negative electrode plate or on both ends thereof. The choice of protrusion of the coated portion on which the insulation layer must be formed may be determined on a case by case basis considering the position of the protrusion, which may be formed on the initial and final portions of the coated portion on a single or both surfaces of one or both of the electrode plates, relative to the jelly roll-shaped electrode assembly.

The operation of a lithium ion rechargeable battery of the present invention will now be described.

The positive electrode plate and the negative electrode plate, which have the insulation layer 30 formed thereon, are wound into a jelly roll with the separator interposed between them. The insulation layer 30 is attached to the protrusion 46 of the positive electrode plate 40 (or negative electrode plate) and surrounds the protrusion 46 that is formed on the end portion of the positive electrode coated portion 44 of the positive electrode plate 40. This prevents the protrusion 46 from damaging the separator and causing a short circuit between the positive electrode plate and the negative electrode plate. The insulation layer 30 has through-holes 32 that may be formed with a predetermined spacing so that the positive electrode coated portion 44 can participate in a reaction even in a region that has the insulation layer 30 formed on it. Therefore, the insulation layer 30 reduces the possibility of a short circuit between the positive electrode plate and the negative electrode plate and prevents the reaction area of the coated portion from decreasing.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A rechargeable battery, comprising:
an electrode assembly formed by winding a positive electrode plate and a negative electrode plate that have coated portions formed on surfaces thereof and a separator for insulating the positive electrode plate and the negative electrode plate from each other; and
a protrusion that is formed on an end of the coated portion of at least one of the positive electrode plate and the negative electrode plate; and
an insulation layer that substantially cover the protrusion,
wherein the insulation layer has a through-hole formed with a predetermined shape.

2. The rechargeable battery of claim 1,
wherein the insulation layer is formed on a protrusion that is formed on an end of the coated portion of the positive electrode plate.

3. The rechargeable battery of claim 1,
wherein the insulation layer has the through-hole formed only on a part that is formed on the coated portion.

4. The rechargeable battery of claim 1,
wherein the insulation layer comprises an insulation tape.

5. The rechargeable battery of claim 4,
wherein the insulation tape is a laminating tape.

6. The rechargeable battery of claim 4,
wherein the insulation tape is an adhesion tape that has an adhesive that is applied to a contact surface with the positive electrode plate or the negative electrode plate.

7. The rechargeable battery of claim 4,
wherein the insulation tape comprises a material selected from the group consisting of polyphenylene, polyimide, and polypropylene.

8. The rechargeable battery of claim 4,
wherein the insulation tape has a thickness of about 5-200 μm.

9. The rechargeable battery of claim 4,
wherein an area of the through-hole corresponds to about 30-90% of a total area of the insulation tape attached on the coated portion.

10. The rechargeable battery of claim 4,
wherein at least five through-holes are formed on a part of the insulation tape that is attached on the coated portion.

11. The rechargeable battery of claim 4,
wherein the through-hole has a substantially circular shape.

12. The rechargeable battery of claim 4,
wherein the through-hole has a substantially polygon shape.
